(19) United States
(12) Patent Application Publication
(10) Pub. No.: US 2018/0369063 A1
(43) Pub. Date: Dec. 27, 2018

(54) Handlebar massage device

(71) Applicant: Michael Torres, Gardnerville, NV (US)

(72) Inventor: Michael Torres, Gardnerville, NV (US)

(21) Appl. No.: 15/731,533

(22) Filed: Jun. 24, 2017

(51) Int. Cl. A61H 15/00; A61H 7/00; A61H 39/04; B62K 21/26

(52) U.S. Cl. CPC A61H 15/0092; A61H 7/003; A61H 39/04; A61H 2015/0035; A61H 15/00; A61H 2015/0014; B62K 21/26

(57) ABSTRACT

A massage device for reducing arm pump is disclosed. The massage device includes a massage member disposed on a pair of handlebars used to steer a vehicle. The massage member can have various mounting methods to the handlebars. The massage member can include a variety of members having different dimensions and contours, and relieves the effects of arm pump when a rider presses his or her forearm against the massage device and moves it, either back and forth, or from side to side, thereby massaging the forearm muscle and relieving the effect of arm pump.

### FIELD OF THE INVENTION

The present invention relates broadly to motorcycles, and more specifically to massage devices that alleviate or prevent arm pump.

### BACKGROUND OF THE INVENTION

Motocross is a sport that has been enjoyed by millions of motorcycle riders for decades. Motocross is a very physically-demanding sport that requires the constant holding of the handlebars and the use of brake and clutch levers located on the handlebars of a dirt bike. The result of the constant grasping of the brake and clutch results in a painful muscular condition known as arm pump. Arm pump is caused by restricted blood vessels in the forearms. The restriction backs up the blood coming from the heart. While the blood is backing up, more blood continues to be pumped into the forearms. The result is a blood traffic jam. If not for a thin fibrous sheath around the muscles called fascia, the blood would keep pouring in until the forearms are bloated. The reason they don't blow up like a balloon is that the fascia's sheath is inelastic. The forearms can only expand so far before the limits of the fascia are reached, resulting in significant pain.

When arm pump occurs, riders will often slow down because they cannot continue riding with their initial intensity due to the pain. Riding with arm pump can become a safety concern, and can cause riders to crash. One approach to alleviate arm pump is surgery. A fasciotomy is a surgery in which an incision is made in the forearm's fascia to eliminate the constriction of muscles during strenuous activity. With the fascia opened up, more blood can pour in before arm pump occurs. However, there are no guarantees a fasciotomy will be successful, and some incisions close up during the healing process, defeating the purpose of the surgery altogether.

Another mechanical approach to alleviating arm pump is to place clamps on the forearm flexor muscles before riding, in an effort to stretch and expand to create more space in the fascia and delay the onset of arm pump. However, this approach has limited effect once arm pump sets in. Riders normally will not stop during a race and apply forearm clamps while other riders pass them by.

Thus, there is a heartfelt need for a more practical solution to the painful and potentially dangerous condition known as arm pump.

### SUMMARY OF THE INVENTION

The present invention solves the problems described above by placing a massage device on the crossbar mounted between handlebars of a motorcycle, replacing the typical crossbar pad that is currently on most motorcycle handlebars. Riders can use the massage device to massage their forearms without having to apply a fascia clamp to their arm. Since the massage device is mounted on the handlebar the rider can use the massage device while on the starting line waiting for their race to begin. In one embodiment, the massage device is hollow, and inserted over the crossbar. A rider can place a forearm on the massage device, and move it back and forth to massage the fascia either in a back-and-forth motion or laterally in a side-to-side motion. In another embodiment, the massage device is solid, and attached to the top side of the cross bar. Various shapes and profiles can be used, depending on user preference. Typically, the massage device will have a series of protrusions that are brought into contact with the fascia, and, when the rider exerts downward pressure on the forearm, the protrusions stretch or distend the fascia slightly, thus preventing or delaying the onset of arm pump.

In an embodiment, the massage device is constructed from soft plastic or rubber, or other suitable, compressible material. In another device, the massage device is constructed from a more rigid material, such as ABS plastic.

As the effectiveness of any profile of the massage device will vary from rider to rider, the massage device is also embodied in a kit that allows riders to select individual massage profile elements having desired contours and place them together in series on the cross bar.

### BRIEF DESCRIPTION OF THE DRAWINGS

FIG. 1 shows the massage device having a hollow center placed over the crossbar.

FIG. 2 shows the massage device having a solid body and attached to the crossbar.

FIG. 3 shows a rider's arm placed on top of the massage device shown in FIG. 2.

FIG. 4 shows an alternative embodiment of the present invention.

FIG. 5 shows a variation of the massage device shown in FIG. 4.

FIG. 6 shows a rider's forearm placed on the massage device shown in FIG. 5.

FIG. 7 shows a kit that includes multiple elements that, when placed together on the crossbar, form the massage device.

FIG. 8 shows another alternative embodiment of the present invention.

### DETAILED DESCRIPTION

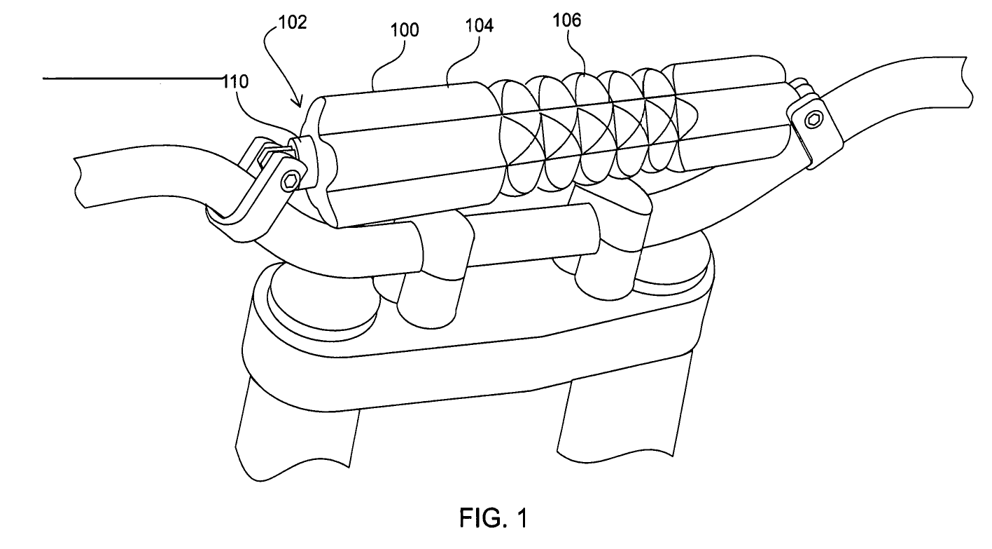

Directing attention to FIG. 1, there is shown massage device 100 placed on crossbar 110. Massage device 100 has a hollow center 102, dimensioned to accept crossbar 110 when inserted into massage device 100. In an embodiment, massage device 100 is constructed from an elastic, compressible material, such as soft plastic or rubber. In other embodiments, massage device 100 is constructed from a more rigid material, such as ABS plastic. In an embodiment, massage device 100 includes flanges 104 as well as contoured section 106.

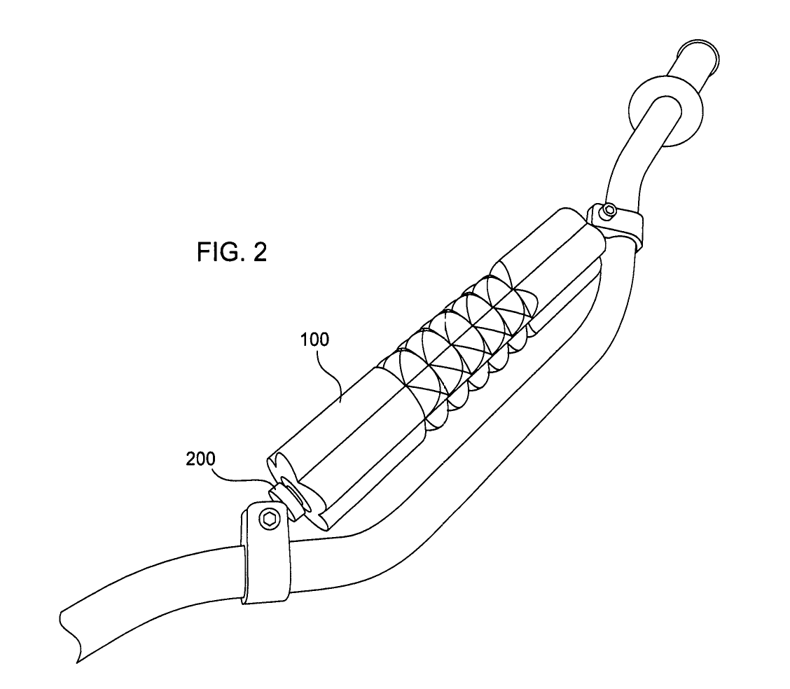

As shown in FIG. 2, massage device 100 can be a solid piece without a hollow center, but having attachment 200 to connect massage device 100 to handlebars.

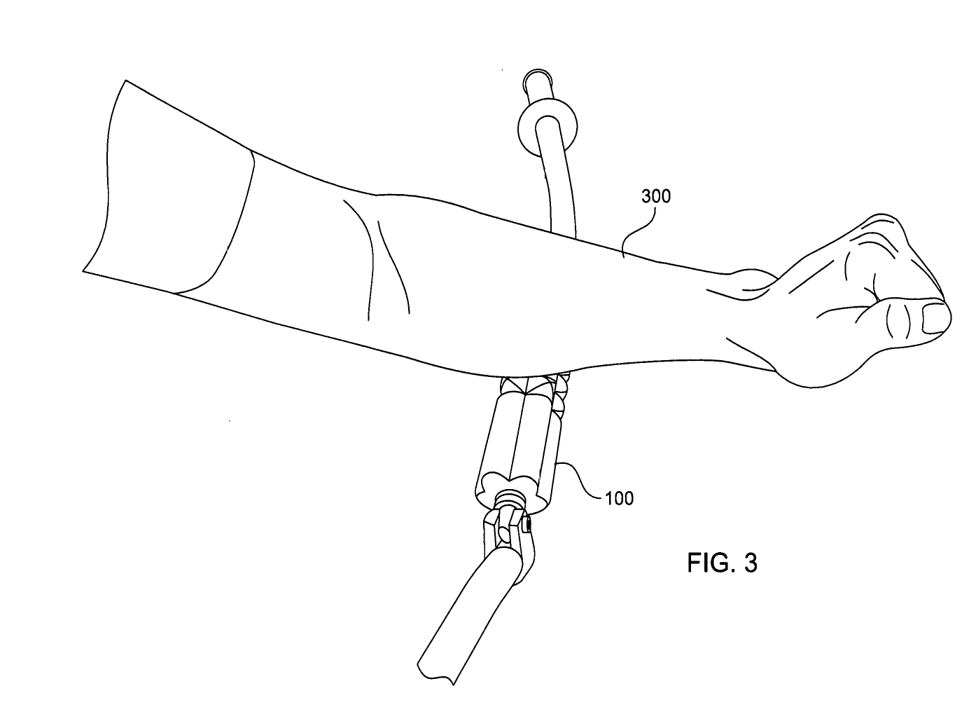

FIG. 3 shows massage device 100 in use. The rider presses his or her forearm 300 against massage device 100, and moves the forearm, either back and forth, or from side to side, thereby relaxing the muscles in the forearm and reducing the effects of arm pump.

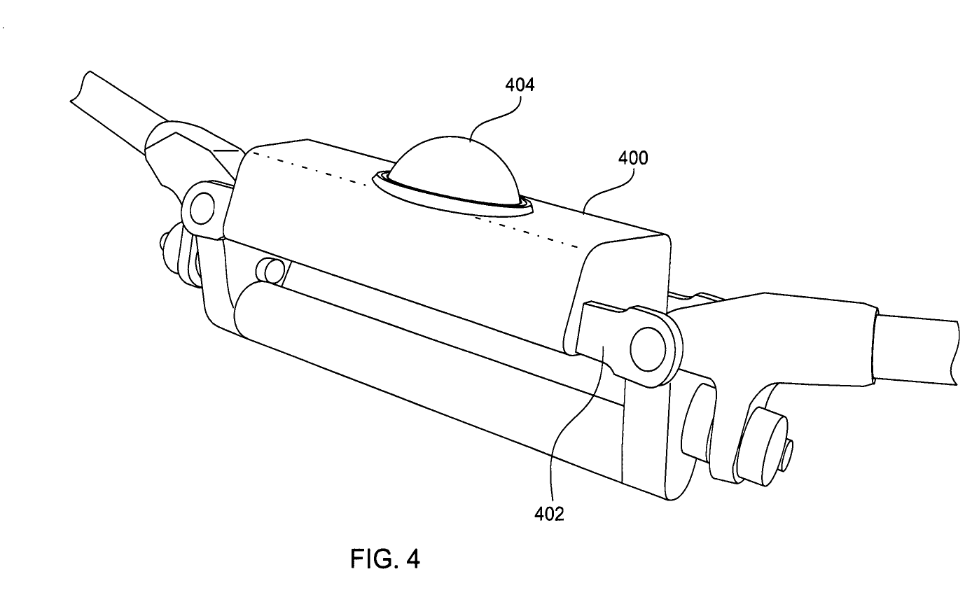

FIG. 4 shows an alternative embodiment of the present invention. Massage device 400 is a padded member disposed along cross bar 402. As shown, cross bar 402 is a flat bar, but massage device 400 can also be dimensioned to accept a cylindrical crossbar. On the top surface of massage device 400, a spherical-shaped member 404 where the top half of the sphere is presented to engage the rider's forearm.

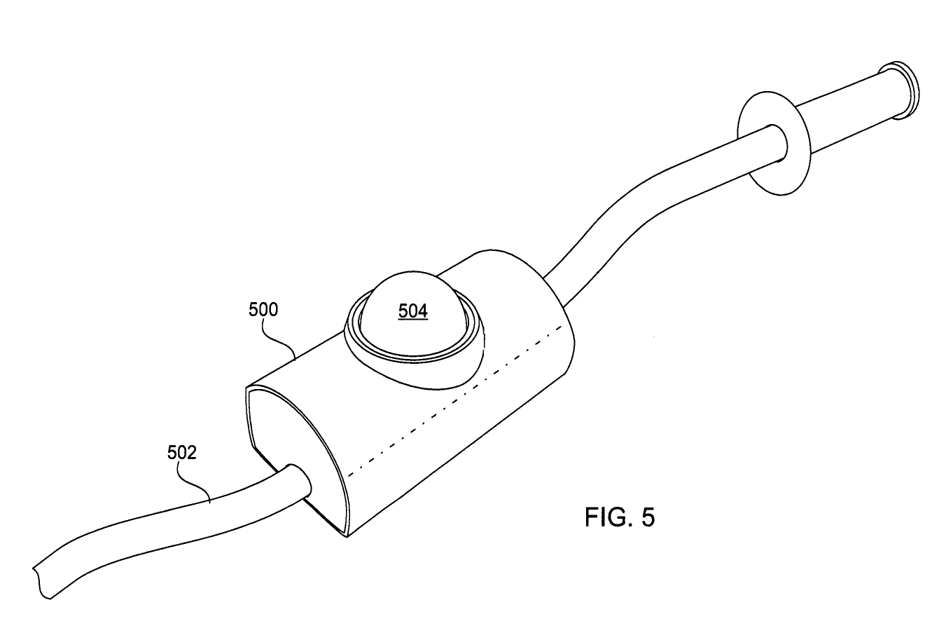

FIG. 5 shows a variation of the massage device shown in FIG. 4. Massage device 500 is placed directing on handlebars 502 that do not incorporate a cross bar. As shown, spherical-shaped member 504 is presented in a similar configuration as shown in FIG. 4.

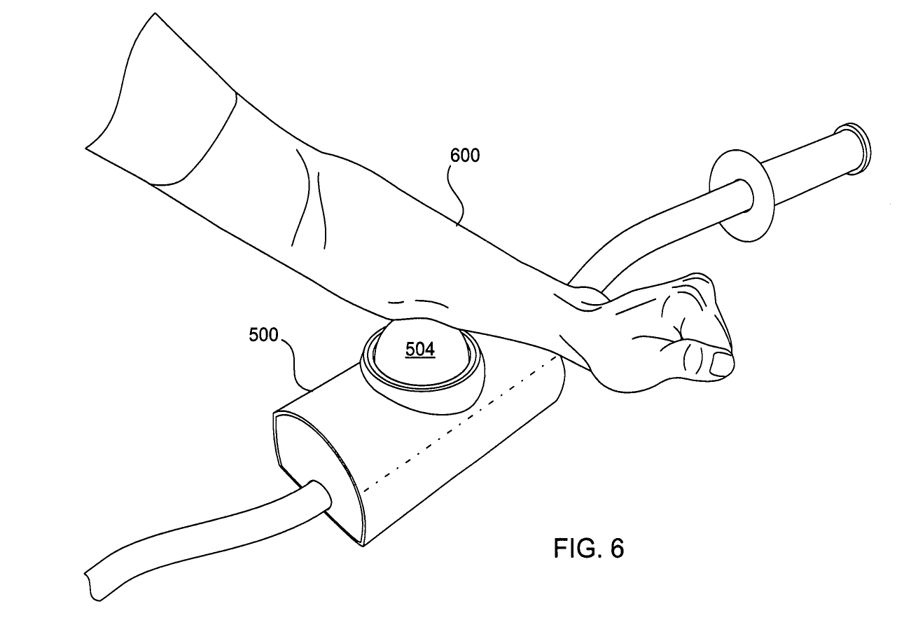

FIG. 6 shows a rider's forearm 600 placed on spherical-shaped member 504 to reduce the effects of arm pump, and a similar placement of forearm 600 works with massage device 400 shown in FIG. 4.

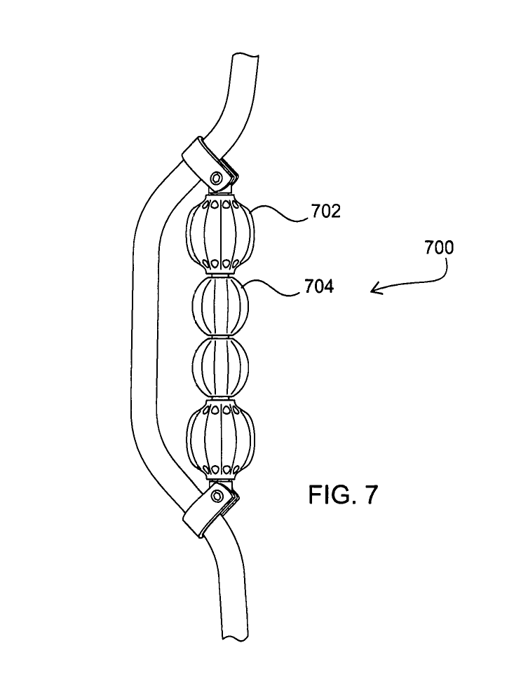

FIG. 7 shows yet another alternative embodiment of the present invention. Massage device 700 is attached as a cross bar on a handlebar, and incorporates a variety of members 702 and 704. Massage device 700 shows that the present invention is customizable, and members of varying dimension and materials can be used to provide different effects when used. For example, member 702 can be rigid, while member 704 can be flexible or compressible, thus providing the rider with a choice of massage intensity. Also, it is contemplated that the present invention be provided as a kit, wherein the rider can select the placement of members 702 and 704 where they are desired. While members 702 are shown on the ends of massage device 700 and members 704 are shown in the center, the rider can remove massage device 700 and rearrange members 702 and 704 so that members 702 are in the center and members 704 are on the ends.

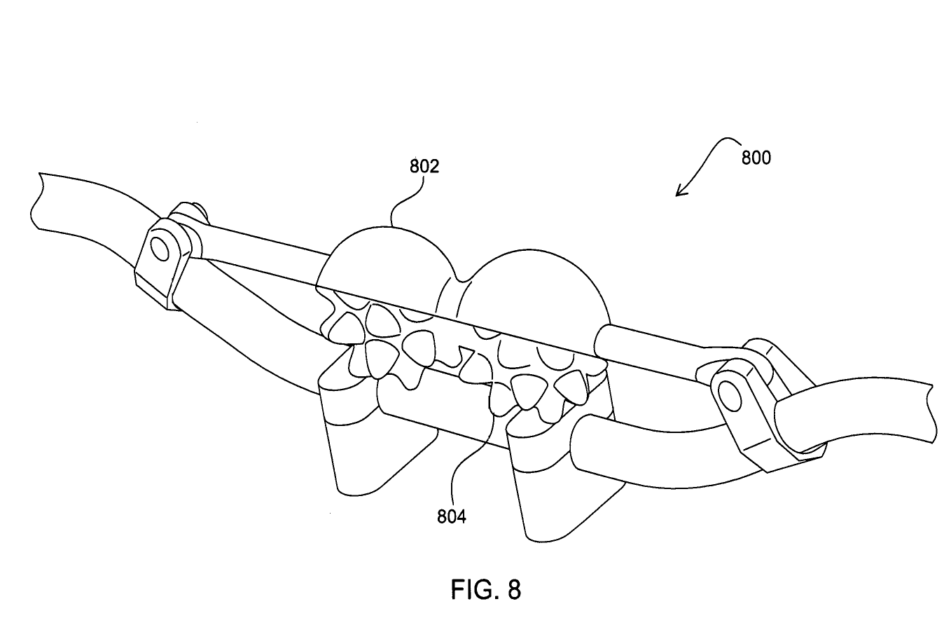

While the contours of the massage device have been shown to vary depending on position along the length of a crossbar, contours may also vary depending on position around the axis of rotation of crossbar. As shown in FIG. 8, massage device 800 has hemispherical contours 802 on one side of a crossbar, and conical contours 804 on the opposite side of the crossbar, such that a rider can rotate massage device 800 to present a desired contour for use by a rider.

It is to be understood that various members can be used in different embodiments of the present invention. As riders have varying degrees of arm pump, it is desirable to make the present invention customizable so that the rider can experiment with different massage members until an optimum arrangement is configured by the rider. While a massage device to reduce arm pump has been described and illustrated in detail, it is to be understood that numerous modifications can be made to the various embodiments of the present invention without departing from the spirit thereof.

What is claimed is:

1. A massage device for reducing arm pump, comprising:
a massage member disposed on a pair of handlebars used to steer a vehicle.

2. The massage device of claim 1, wherein the massage device is mounted on a cross bar between two points on a pair of handlebars.

3. The massage device of claim 1, wherein the massage device includes a member having multiple contours.

4. The massage device of claim 1, wherein the massage device includes a hollow center dimensioned to receive a removable cross bar attached to the handlebars.

5. The massage device of claim 4, wherein the cross bar is flat.

6. The massage device of claim 1, wherein the massage device includes a spherical-shaped member.

7. The massage device of claim 1, wherein the massage device comprises multiple members.

8. The massage device of claim 7, wherein the multiple members have different dimensions.

9. The massage device of claim 7, wherein the multiple members are arranged on a cross bar.

10. The massage device of claim 7, wherein the multiple members are disposed at different locations along an axis of rotation of the crossbar.
